(19) United States
(12) Patent Application Publication
(10) Pub. No.: US 2024/0020781 A1
(43) Pub. Date: Jan. 18, 2024

(54) ANALYTICAL PLATFORM FOR IMPROVING THE EDUCATION QUALITY

(71) Applicant: Deepspatial INC., Toronto (CA)

(72) Inventors: Bushra Zaman, Bengaluru (IN); Rajiv Muradia, Toronto (CA); Rahul Kushwah, Toronto (CA)

(21) Appl. No.: 17/887,623

(22) Filed: Aug. 15, 2022

(30) Foreign Application Priority Data
Jul. 17, 2022 (IN) 202211040818

(51) Int. Cl. G06Q 50/20

(52) U.S. Cl. CPC G06Q 50/2053

(57) ABSTRACT

A computer implemented analytical platform for improving the quality of education, the computer implemented analytical platform comprises a data aggregation module configured to collect and aggregate data from one or more data source. The computer implemented analytical platform includes a statistical analysis module for removing the interrelation among one or more variables. The results are passed to a dimensionality reduction module to select one or more variables from a given set of variables. After a selection is made on the number of dimensions/variables to be included for analysis, the data is passed to a feature engineering module, which calculates the importance of each feature/variable and the weight associated with each variable/dimension. A geospatial analytics module determines the gaps in coverage of schools. Subsequently, the data is passed to an analytical engine implementing machine learning algorithms, which are trained using a training and test dataset, the test dataset comprising one or more variables selected by the feature engineering module to optimize the set goals. The machine learning model is tested on the test dataset. An artificial intelligence module is used for prediction of factors for set objectives and a recommendation module is used for prediction of the outcomes based on the set goals.

### FIELD OF THE INVENTION

The invention relates to an analytics platform for improving the quality of school education and the success rate of students. The analytical platform enables the decision makers to conduct an in-depth analysis of the present education system, analyzes the data to create a favorable environment for an all-round development of the stakeholders. More specifically, the analytical platform facilitates a creation of the conducive environment for imparting quality education to children of middle, secondary and senior secondary level.

### BACKGROUND OF THE INVENTION

School education is backbone of society and basic education is the right of every child. Basic education begins at a school level where knowledge and linguistics skills are imparted to the child. School education provides an excellent opportunity for students to acquire knowledge in different fields such as literature, mathematics, science, politics, history, life skills, information technology and numerous other areas/subjects. Education also plays a major role in shaping the curious minds of young children. It allows them to develop their own personalities and identity.

Geospatially enabled Machine learning (ML) tools are transforming education and fundamentally changing the conventional methods of teaching, learning, and research. Academicians, educators and decision-making bodies are using artificial intelligence (AI) techniques to find the critical parameters behind success and failure of students and spot struggling students, underperforming teachers and take suitable action to improve success and retention. AI/ML models and methods are expanding the reach and impact of primary, secondary and tertiary education through localization, transcription, text-to-speech, and personalization.

Scientific techniques to improve quality of education have been used for a long time to create a conducive environment for overall development of students and to provide quality school education. In spite of using scientific techniques, there are challenges in implementing quality education to children due to several factors. For example, each student is unique having different level of intelligence quotient, numerical ability, reasoning and other basic building blocks of learning and education. Therefore, a need exists for an analytical platform that can identify both intrinsic and extrinsic factors associated with different stakeholders and provide a structured and organized approach to create a conducive learning environment. Additionally, by considering multiple factors across different stakeholders, the analytical platform improves the quality of school education.

The analytical platform includes an array of spatial data and advanced machine learning and artificial intelligence techniques in extracting valuable information, and analyzes the extracted information to improve quality of education. The invention aims at equipping the students with the skills and expertise they need to succeed. The proposed analytical platform implements a machine learning regression technique which forecasts the success or failure of students from primary to 12t h standard based on various factors like historical pass and fail percentages, school location and surrounding demographics, student information, teacher information including their qualification and whether permanent or temporary, school facilities and infrastructure, accessibility of the school, budget disbursed to the school for its development and other assimilated data.

### SUMMARY OF THE INVENTION

An analytical platform for improving the quality of school education is disclosed. The analytical platform uses a set of statistical techniques and procedures to solve the problems associated with improvement of school education quality. The analytical platform aims at increasing the success rate of students in transitioning from secondary education to senior secondary education level. The analytical platform implements statistical techniques and machine learning algorithms in a layered form to improve the quality of school education. In some embodiments, the analytical platform may improve the school education quality at middle school and the secondary school and provide insights about the failure of students. Different implementations may cater to different objectives related to improvement of school education, for example, transitioning from middle to secondary school, secondary school to senior secondary school, etc.

In one variation of the implementation, the analytical platform may implement a layered solution. The layered solution in one implementation may be implemented by adding a layer of aggregated data at each stage/step and analyzing each layer of data separately. In embodiments, the different layers of data may include but are not limited to demographic data, geospatial data, accessibility data associated with transportation available for accessing school, machine learning implementation of predication, grant provided to schools and infrastructure spending by the schools.

In embodiments, each of the layers may be analyzed separately and then combined in different order depending on some defined set of objectives/outcomes. The analytical platform may provide layered data driven solutions by implementing and developing models to help the stakeholders make important decisions using the geospatial insights. In some embodiments, the geospatial insights provided by the analytical engine may facilitate in planning, managing, organizing and enhancing education quality in schools at primary, upper primary, secondary and higher secondary levels.

In one embodiment, the analytical platform may include one or more applications for improving quality of school education. The analytical platform uses a layered set of solutions, which comprises a combination of various statistical, machine learning/artificial intelligence and geospatial techniques, which provide suggestions for improving the quality of school education. In some embodiments, the quality of school education may be related to improving the pass percentage of students graduating from one class to another class.

In some embodiments, the layered solution may be implemented in machine learning algorithms to make accurate prediction of the set objectives related to improvement of quality of school education. In another implementation, the layered solution may be linked to the assessment of the school by monitoring the academic progress along with financial spending. The academic progress can be assessed based on certain performance grading indicators (PGIs), which may provide insight about the quality of school education. The analysis and insights provided by the analytical platform may help the decision makers to make timely interventions for improving the performance of the school in terms of infrastructure requirements and for improving school education quality.

In some embodiments, the analytical platform may access real time data related to school education on monthly/quarterly basis, which may allow the application to identify highly specific, extremely valuable information using spatial information systems and custom maps. The platform has a feature of real time data ingestion and the insights are updated based on the updated data at the backend. For example, data on school expenditure, new student enrollment and other things associated with improvement of quality of school education.

In some embodiments, the analytical platform assimilates different datasets with tagged location information and integrates it with the geo-demographic data of the location and information related to schools and the stakeholders associated with the schools such as teachers, students, management and other attributes associated with the schools such as infrastructure, student enrollment and school category. Through the combined use of assimilated data and location intelligence, the analytical platform may detect patterns in the dataset and ascertain the factors responsible for success and failure of the students. In addition, once trained with a training data set, the analytical platform may also identify factor(s) responsible for improving the school education.

The analytical platform may include a data aggregation module. The data aggregation module collects data related to education level in different school, geo-spatial data, government data, demographic data, and ancillary data. The aggregated data is used to prepare, train and predict the factors responsible for improving different set objectives such as but not limited to improving the quality of school education, the quality of education among different stakeholders, identifying weak areas of students, and other set objectives for improvement of education quality.

In addition, data aggregation module associated with the analytical platform may collect data from other sources such as propriety data, geographical data, data collected by different administration departments, data related to schools, demographic data or some other type of data for prediction and improvement of school education quality.

In some embodiments, the analytical platform may be provided with ancillary data. The ancillary data may include public transportation near the school, road network of the geographical area under consideration and responses to the survey questionnaire collected from the students, teachers and principal of school. A unique feature of the analytical platform is combining different data in the data aggregation module with the geospatial data in the layered form. This improves the efficiency, prediction and provides additional insights for determining the gaps and to improve the quality of the school education. The analytical platform also includes a geospatial module, which integrates and combines geospatial data with other data to improve prediction.

The analytical platform may further include a dimensionality reduction module to select the relevant variables from a given set of input variables. The dimensionality reduction module may sanitize the aggregated data, for example, removing association among different variables. For example, removing multi-collinearity, autocorrelation and other type of data discrepancies such as interrelation among one or more variables. This interrelation among different variables may be linear, exponential or logarithmic. In embodiments, a statistical procedure for removing the multicollinearity among input variables (dimensions) may depend upon the type of collinearity in the data. Other inconsistencies like outliers duplicates and other form of erroneous data may also be removed.

A feature engineering module provides identification and selection of features/independent variables for creating a prediction model. The feature engineering module calculates the importance of each feature by calculating factor weightage for each of the features. The parameters are constant values that are provided to the variables during model building to create a multivariate statistical prediction equations or models.

The analytical platform further includes an analytical engine implementing machine learning algorithms, which are trained using a training dataset and tested using a test dataset comprising one or more variables selected by the feature engineering module to optimize the set goals and prediction of improving school education quality. The analytical platform may utilize the test data to train and develop one or more machine learning model or artificial intelligence modules to predict the school education quality via student performance in exams and provide insights for its improvement. In preferred embodiments, the improvement in quality of school equation may be related to pass percentage of students graduating from a lower class to a next higher class. In some embodiments, the test dataset is passed to the machine learning model for the first time and is used for calculating the accuracy of the machine learning model.

In some embodiments, the analytical platform may include an artificial intelligence module that may implement one or more machine learning modules and algorithms for prediction of pass percentage of students one year in advance.

A recommendation module provides prediction of the outcomes based on the set objectives that are provided as recommendations. Furthermore, the recommendations are stored in the database, which can be retrieved later for calculating the accuracy of the analytical platform by comparing the prediction with actual results. In addition, the cross validation of the artificial intelligence/machine learning model may improve of the machine learning model.

In another embodiments, a computer implemented method and system for deriving the analytics of school education quality for assessment of reasons for success and failure of students in transitioning from current standard to next higher standard is implemented using geospatial, accessibility analysis, data visualization and machine learning multivariate model. In some embodiments, the analytical platform may evaluate the school performance and factors responsible for performance of the schools and also evaluate the school against the set standards.

In some embodiments, the analytical platform may perform the impact analysis of education quality in relation with the school category and the pass percentage. The impact analysis may provide information related to the performance of the school in relation to the school level that is whether the school has just secondary level or a higher secondary level or has primary and upper primary to secondary and higher secondary levels and further evaluate which category of the school are performing better than the schools in other categories.

In some embodiments, the analytical platform may perform a gap analysis for determining the gaps in the quality of education in school having different level of education. The level of education may be categorized as a school till primary level, upper primary level, secondary level and higher secondary level schools in a geographical area. In embodiments, the geographical area may be region, a district, or a state.

In some embodiments, the analytical platform may perform school's accessibility assessments as per the distance standards set by the govt. for accessing each category of school. The analytical platform may implement a process to check if the school is accessible from all parts of a particular area/region by drawing buffers counters (imaginary lines for assessment) around each school as per distance norms. The buffer analysis will show whether the schools are accessible/inaccessible from within the geographical region under consideration. In case, the school is not accessible from within the defined geographical region under consideration then it indicates a gap in school coverage.

In some embodiments, the analytical platform may run an academic performance prediction model. A computer implemented analytical platform will choose the relevant dimensions (variables) for prediction of the pass percentage of the students transitioning from one standard to the next higher standard one year in advance.

In some embodiments, the analytical platform may run a statistical clustering analysis and identify the schools requiring immediate intervention with respect to success rate of students in transitioning from one standard to the next higher standard and the presence of qualified and unqualified teachers in that school.

In some embodiments the analytical platform may analyse the schools based on performance grading indicators (PGIs). The performance grading indicators are the performance benchmarks set by the government or education monitoring statutory bodies for evaluating the schools and ensuring that the schools are functioning as per the laid down norms. This also makes an assessment whether the schools are eligible for any funding for the academic and infrastructural development.

In some embodiments, the analytical platform may monitor the expenditure of the schools and produce geospatial graphs of expenditure of the school against the school performance. Different interpretation and analysis can be derived from such analysis to get insights related to different performance indicators such as (a) analyze the amount of money spent by the schools with respect to the progress made by the schools in terms of improving academics and building infrastructure for facilitating the students; (b) provide a single window dashboard of the geospatial information and the status of expenditure of each school; (c) analyze and monitor the impact of the capital and recurring expenditure by the schools with respect to the success rate of students of that school. The analytical platform provides a unique and novel opportunity to scientifically analyze if resources spent on the school translate into corresponding improved performance of the students.

In another embodiments, the computer implemented analytical platform may comprise: a data collection and integration module configured to collect and aggregate data from at least one data source; a statistical data cleaning module for removing the different interdependence and association within the data variables; a dimensionality reduction module to choose the relevant variables from the given set of variables; a geospatial analytics module for envisaging the gaps in coverage of schools; a feature engineering module to calculate the importance of each feature by calculating weight factor associated with each feature; an analytical engine implementing machine learning algorithms, which are trained using a training and test dataset which use the variables selected by the feature engineering module to optimise the set goals and tested on the test dataset; an artificial intelligence module for prediction of pass percentage of students one year in advance; and a recommendation module for prediction of the outcomes based on the set goals.

In one variation of this implementation, a computer implemented method and system for improving the quality of school education and performing different analytics for assessing the reasons for success and failure of students in transitioning into high school from 9th standard using geospatial data machine learning is provided.

In some embodiments, the analytics platform may access different types of data related to improvement and assessment quality of school education to identify highly specific, extremely valuable information using geospatial information and custom maps.

In some embodiments, the analytics platform assimilates different datasets with tagged location information of the schools and integrates it with the geo-demographic data of the location of the schools, regular/contract teachers and their qualification, infrastructure, student enrollment and school category. Through the combined use of assimilated data and location intelligence, the analytics platform can detect patterns in the dataset and ascertain the factors responsible for success and failure of the students in transitioning from current class/grade to the next higher standard.

In some embodiments, the analytics platform may evaluate the good and bad performing schools and the factors responsible for such a performance. Additionally, the analytical platform may evaluate the school against the standards set by the govt. like the average Pupil-Teacher ratio, classroom adequacy ratio etc.

In some embodiments, the analytics platform may run an academic performance prediction model. The analytical platform may choose the relevant dimension for prediction pass percentage of the students transitioning from current class/grade to next class/grade in one year in advance.

In some embodiments, the analytics platform may analyze the schools based on performance grading indicators. The performance grading indicators (PGIs) are the performance benchmarks set by the govt. for evaluating the schools and ensuring that the schools are functioning as per the norms laid out by the govt. This also makes the schools eligible for availing funding for the academic and infrastructural development of the schools.

In some embodiments, the analytics platform may execute a statistical grouping analysis to identify the schools that require immediate intervention with respect to success rate of students in transitioning from current class (for example, standard 9^{th}) to the next class (for example, standard 10^{th}). For example, one intervention may be absence of qualified teachers as per norms, the ratio of qualified and unqualified teachers in that school as per standards set by government.

In some embodiments, the analytics platform may monitor the expenditure of the schools with respect to the performance of the school. Furthermore, the analytical platform may perform its analysis and create geospatial graphs of expenditure of the school using a graphical user interface. This analysis may provide insights about the amount of money spent by the schools with respect to the progress made by the schools in terms of improving academics and building infrastructure for facilitating the students. In addition, the geospatial information may provide a single window dashboard view of the status of expenditure of each school. Moreover, the expenditure by the schools may be linked to the pass percentages and analysis may be performed to evaluate if the expenditure on the school translate into improved performance by the students.

### BRIEF DESCRIPTION OF THE DRAWINGS

FIG. 1 illustrates an operating environment of a computer implemented analytical platform in an embodiment of the present invention;

FIG. 2 illustrates different hardware components of a computer implemented analytical platform in an embodiment of the present invention;

FIG. 3 illustrates different modules of an analytical module for improving the quality of education in an embodiment of the present invention;

FIG. 4 illustrates different modules in a data aggregation module in an embodiment of the present invention;

FIG. 5 illustrates a variable list for improving the quality of school education in an embodiment of the present invention;

FIG. 6 illustrates different components of a dimensionality reduction module in an embodiment of the present invention;

FIG. 7 shows the heat map of different education indicators and demographic variables in an embodiment of the present invention;

FIG. 8 illustrates demographic variables for a block in an embodiment of present invention;

FIG. 9 illustrates important features affecting the success of students in graduating from one standard to next standard in a school in an embodiment of the present invention;

FIG. 10 depicts the standard norms for pupil-teacher ratio and classroom adequacy ratio in an embodiment of the present invention;

FIG. 11 illustrates the geospatial spread of pass percentage of the students in an embodiment of the present invention;

FIG. 12 shows the distribution of different category of schools located in a block in an embodiment of the present invention;

FIG. 13 illustrates the demographic variables of a school located in an exemplary block in an embodiment of the present invention;

FIG. 14 illustrates a statistical analysis module in an embodiment of the present invention;

FIG. 15 illustrates different components of a feature engineering module in an embodiment of the present invention;

FIG. 16 illustrates a geospatial analysis module in an embodiment of the present invention;

FIG. 17 illustrates a process of predicting the quality of school education in an embodiment of the present invention;

FIG. 18 illustrates a process of data aggregation and data visualisation in an embodiment of the present invention;

FIG. 19 illustrates a process of data filtering and transformation using statistical analysis in an embodiment of the present invention;

FIG. 20 illustrates a process of data transformation of relevant variables using regression and statistical analysis in an embodiment of the present invention;

FIG. 21 illustrates a process of expenditure monitoring for improving the quality of school education in an embodiment of the present invention;

FIG. 22 illustrates a process of improving the quality of education using a layered approach in an embodiment of the present invention.

### DETAILED DESCRIPTION OF THE INVENTION

As used herein any reference to “one embodiment” or “an embodiment” means that a particular element, feature, structure, or characteristic described in connection with the embodiment is included in at least one embodiment. The appearances of the phrase “in one embodiment” or “in one implementation” or “in variation of the implementation” at various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

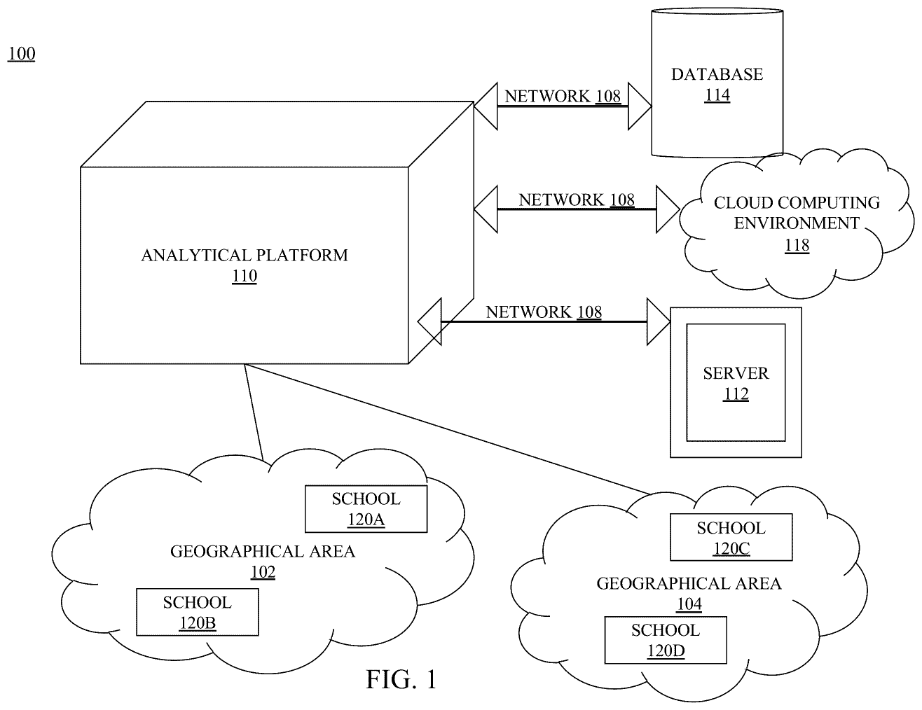

FIG. 1 illustrates an operating environment of a computer implemented analytical platform in an embodiment of the present invention. The computer implemented analytical platform environment 100 includes an analytical platform 110 connected with different geographical areas such a geographical area 102 and a geographical area 104. Each geographical area such as the geographical area 102 comprises one or more schools such as a school 120A or a school 120B. Likewise, the geographical area 104 comprises one or more schools such as school 120C or a school 120D. The schools such as the school 120A, the school 120B, the school 120C and the school 120D may be collectively referred to as schools 120. Furthermore, the analytical platform 110 is connected a server 112, a database 114, and a cloud computing environment 118 and other electronic processing devices through a network 108. The analytical platform 110 collects and aggregates data related to one or more schools 120 for each of the geographical areas such as the geographical area 102 or the geographical area 104 to perform analysis and analytics for improving the quality of school education.

In some embodiments, the analytical platform 110 may be implemented in the server 112.

In another embodiment, the analytical platform 110 may be implemented over a distributed environment or on a cloud computing environment 118.

In some embodiments, the analytical platform 110 may be connected with one or more databases 114. The one or more databases 114 may include an ancillary database, which may store information related to specific school or profile of different stakeholders associated with the specific school. For example, the ancillary database may store information regarding the public transportation available near the school, road network of the geographical area under consideration, and responses to the survey questionnaires, collected from the students, teachers and the principal of each school. In addition, the ancillary database in an implementation may include information related to geospatial data of the school, the fund received by the school, the academic indicators of the school and other factors associated with the school. FIG. 1 illustrates an exemplary embodiment of the operating environment 100 of the analytical platform 110 but in other implementations the operating environment 100 may include additional or fewer components than shown.

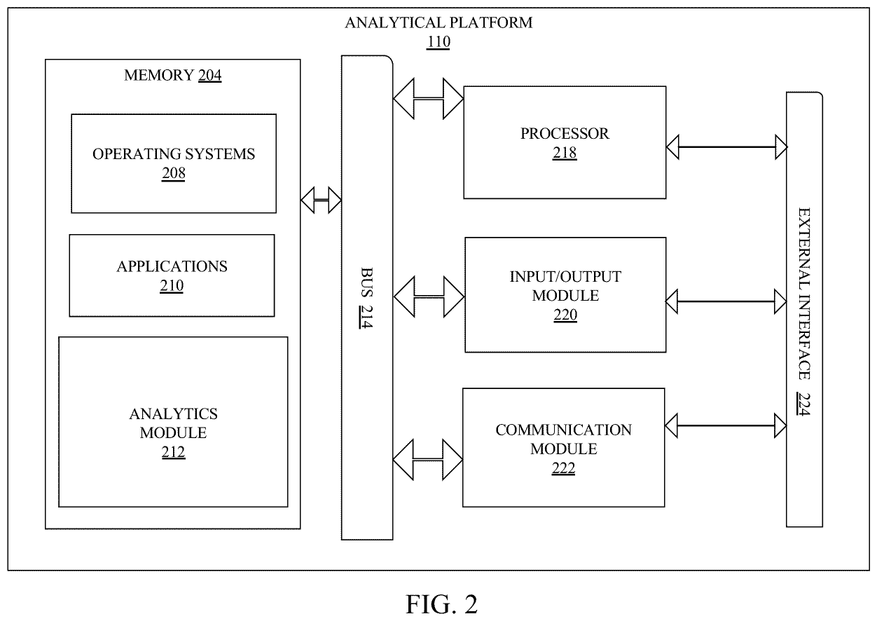

FIG. 2 illustrates the different hardware components of a computer implemented analytical platform in an embodiment of the present invention. The analytical platform 110 includes a memory 204, a one or more processor 218, an input/output module 220, a communication module 222, an internal bus 214 and an external interface 224. The internal bus 214 allows exchange of data and electrical power between the memory 204 and the processor 220, the input/output module 214 and the communication module 222. Additionally, the external interface 218 allows communication between external devices such as the server 112 or data received from schools 120 or from the cloud computing environment 118. The memory 204 may include one or more operating systems 208, one or more applications 210, and an analytical module 212. FIG. 2 illustrates an exemplary hardware configuration of the analytical platform 110, however, in other implementations, the analytical platform 110 may have additional or lesser number of modules.

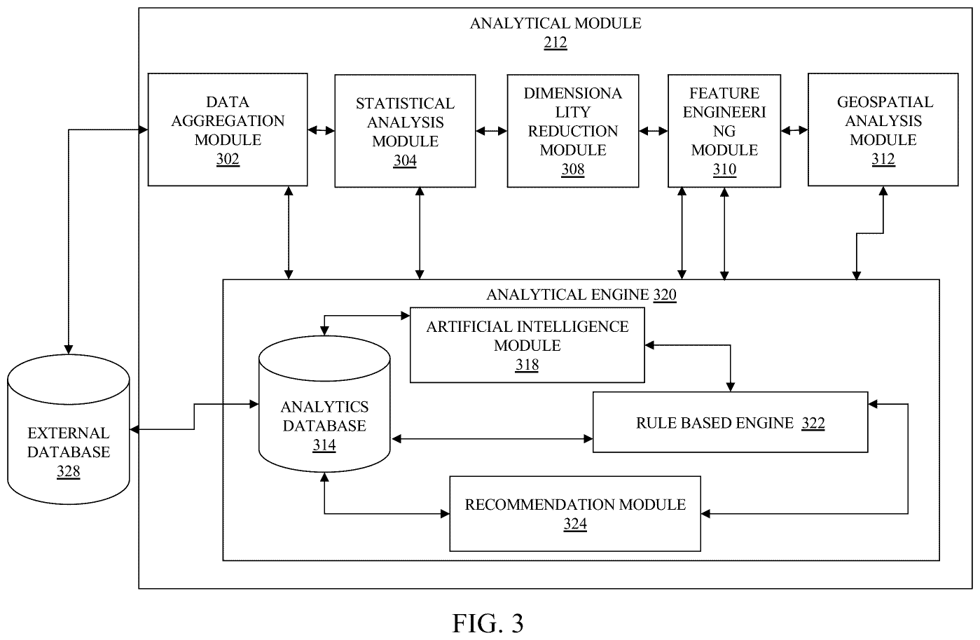

FIG. 3 illustrates different components of an analytical module for improving the quality of education in an embodiment of the present invention. The analytical module 212 includes a data aggregation module 302, a statistical analysis module 304, a dimensionality reduction module 308, a feature engineering module 310, a geospatial analysis module 312, an external database 328 and an analytical engine 320. The analytical engine 320 includes an analytical database 314, an artificial intelligence module 318, a rule based engine 322 and a recommendation module 324. The artificial intelligence module 318 is trained using different test data sets to predict the set goals. In embodiments, the set goals may be prediction of pass percentage of students form one standard to next standard. In other embodiments, the set goals may be prediction of quality of school education.

In some embodiments, the analytical module 212 may be implemented in a distributed computing environment or as a distributed system over a network 108. In some other embodiments, the analytical module 212 may be implemented as a software module in the server 112. In yet other embodiments, the analytical module 212 may be implemented as software as a service (SaaS) on the cloud computing environment 118.

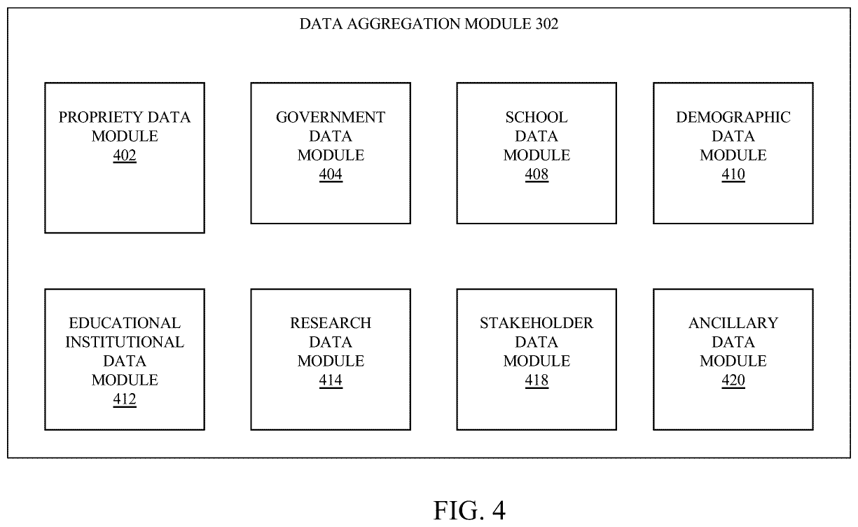

FIG. 4 illustrates different components of a data aggregation module in an embodiment of the present invention. The data aggregation module 302 includes a proprietary data module 402 comprising proprietary data; a government data module 404 comprising government data; a school data module 408 comprising data collected from one or more schools in a defined area such as region, state, district or a block. In addition, the data aggregation module 302 includes a demographic data module 410 comprising data collected from different demographic databases and an educational institutional data module 412 comprising data collected from different educational institutions. The data aggregation module 302 further includes research data module 414 comprising of research data from different research institutions related to improvement of quality of school education, a stakeholder data module 418 comprising data about different stakeholders and an ancillary data module 420 comprising of data related to public transportation near the school, road network of the geographical area under consideration, and responses to the additional survey questionnaires collected from the students, teachers and principal of each school.

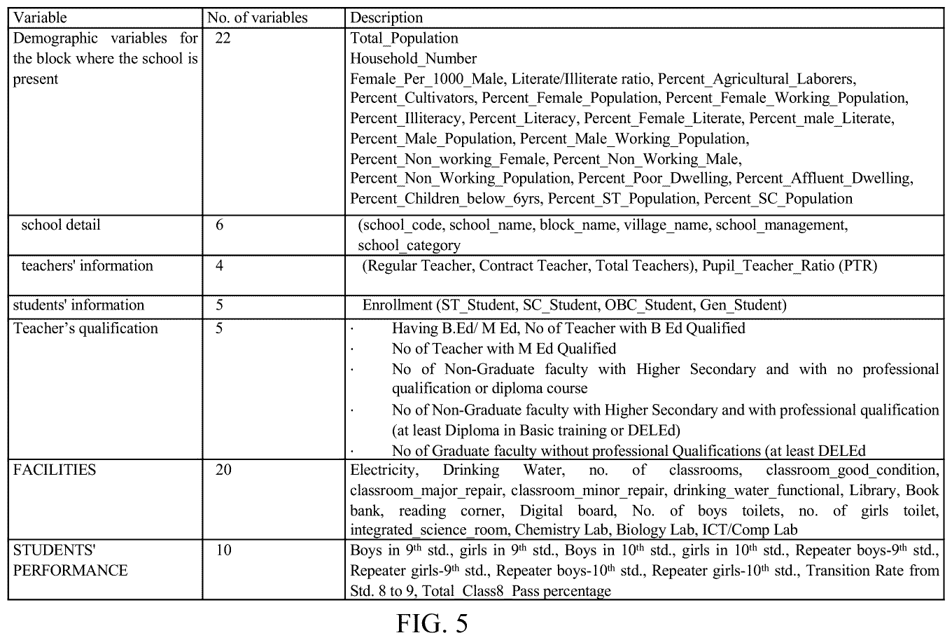

FIG. 5 illustrates a variable list for improving the quality of school education in an embodiment of the present invention. The invention uses one or more statistical tools and techniques to solve the problem of improvement of quality of school education and to increase success rates of students in transitioning from one standard to next immediate higher standard. For example, transitioning to a high school level from a secondary school level. In one embodiment, the analytical platform 110 may use some of the 72 variables for analysis of quality of school education and select the relevant variables, which can be utilized for statistical model building. In another embodiments, the analytical platform 110 may use some of the 72 variables for analysis of quality of school education and select the relevant variables, which can be utilized for statistical model building and machine learning model building. The analytical platform 110 may use different statistical methods, which may include the Spearman rank-order correlation (SROC), a nonparametric test to explore the association strength between variables and underlying social and economic variables. These social and economic variables are drivers of change in the system dynamics of success and failure of students and to improve the quality of school education. In other embodiments, the statistical techniques may be applied for data cleansing and removal of correlated date and then the cleansed data may be used for building machine learning algorithms.

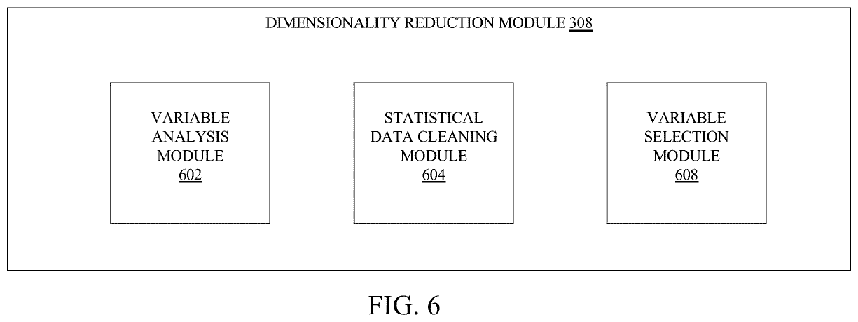

FIG. 6 illustrates different component of a dimensionality reduction module for improvement of quality of school education in an embodiment of the present invention. The dimensionality reduction module 308 in some embodiments is also referred as variable reduction module. The dimensionality reduction module 308 comprises a variable analysis module 602, a statistical data cleaning module 604 and a variable selection module 608.

The variable analysis module 602 analyzes the relationship between each dependent and independent variable and whether the variable is significant or insignificant with the help of p-test, t-test or chi-squared test. In addition, the variable analysis module 602 also determines if there exists an interrelationship among independent variables or multicollinearity. Multicollinearity refers to the problem when the independent variables are collinear. Variance Inflation Factor (VIF) is an index that provides a measure of how much the variance of an estimated regression coefficient increases due to collinearity. The multicollinearity of the dataset is calculated using VIF.

The statistical data cleaning module 604 utilises VIF for removing certain variables from the set of independent variables which would result in reduction of variance and provide an optimal set for prediction. A value less than 10 is aimed for the independent variables. The statistical data cleaning module 604 then removes multicollinearity using a stepwise variable elimination procedure. After removal of multicollinearity, 21 variables were selected out of 72 variables with the VIF of less than 10. These 21 variables were used for model building. A VIF value of ‘infinity’ means that this independent variable has a perfect correlation with other independent variables in the dataset.

In embodiments, the variable selection module 608 may use a Random Forest Decision tree algorithm to calculate the importance scores of variables based on the reduction in the criterion used to select split points. The graphs show the weightage of each variable on a scale of 0 to 1.

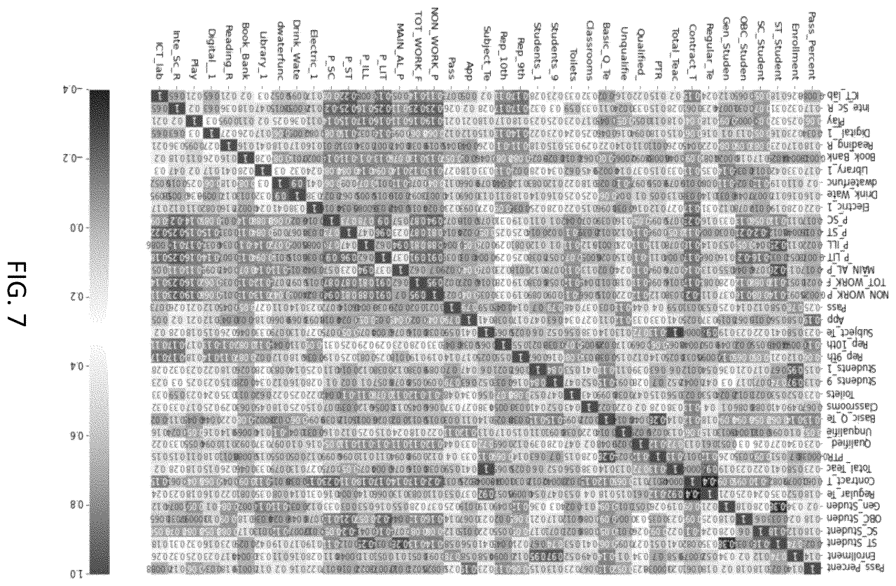

FIG. 7 shows the heat map of different education indicators and demographic variables in an embodiment of the present invention. The analytical platform 110 may initiate the process of building a model using geo-demographic profiling, which links the demographics surrounding of the school in a specific area with the success rate of the students.

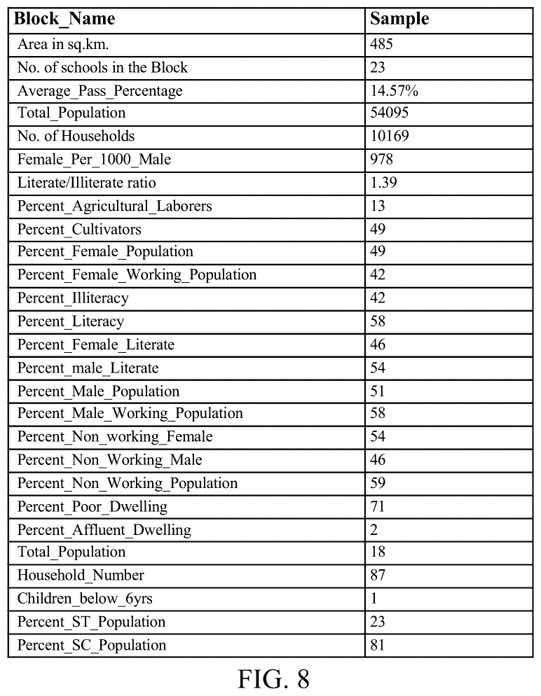

FIG. 8 illustrates demographic variables for a block in an embodiment of present invention. In an exemplary illustration, the area of a block may be 485 sq. kms; the number of schools in the block may be 23; the average pass percentage may be 14.57%; total population may be 54095. Likewise other attributes in a given block with the sample collected are provided in the FIG. 8.

After analysing the geo-demographic profiling, the analytical platform 110 performs the analysis of school information and with the objective of finding good and poor performing schools and factors responsible for the same. The good performing schools are based on standard that may be defined in advance. For example, a school having a pass percentage of over 60% in 9th standard may be considered as good performing school. Any school performing below 60% may be considered as poor performing school.

In some embodiments, the school is evaluated against the standards set by the government, for example, the average Pupil-Teacher ratio, classroom adequacy ratio, etc. In the exemplary embodiment, the schools having pass percentages between 65 and 100% are considered to be well performing schools and those having pass percentages below 40% are considered to be poor performing schools. The analytical platform 110 then performs analysis using Spearman Rank-Order correlation test for first removing the multicollinearity from the dataset, selecting the uncorrelated variables and then applying the exploratory regression analysis, the decision tree regressor and convolutional neural network (CNN) to these selected variables for finding the most important variables affecting the pass percentages of students and their respective weights. The analytical engine 320 may implement one or more artificial intelligence models to determine the most important factors affecting the success of students.

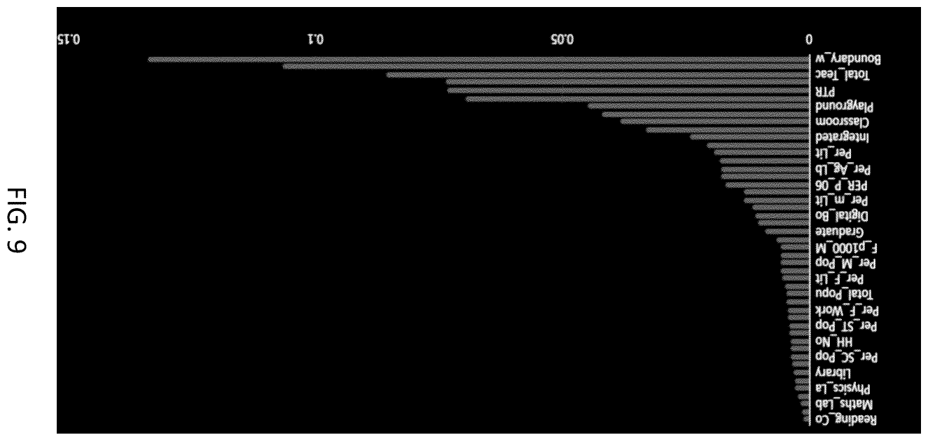

FIG. 9 illustrates important features affecting the success of students in graduating from one standard to next standard in a school in an embodiment of the present invention. The important features are: presence of boundary wall in the school which is in line with our intuitive intelligence as having a boundary wall restricts the students within the school, which results in better pedagogy impact; order of weightage in the exemplary embodiments are number of qualified and total teachers, school category, pupil-teacher ratio, enrollments, presence of a playground (reflects better infrastructure), literate/illiterate ratio, number of classrooms, electricity and drinking water.

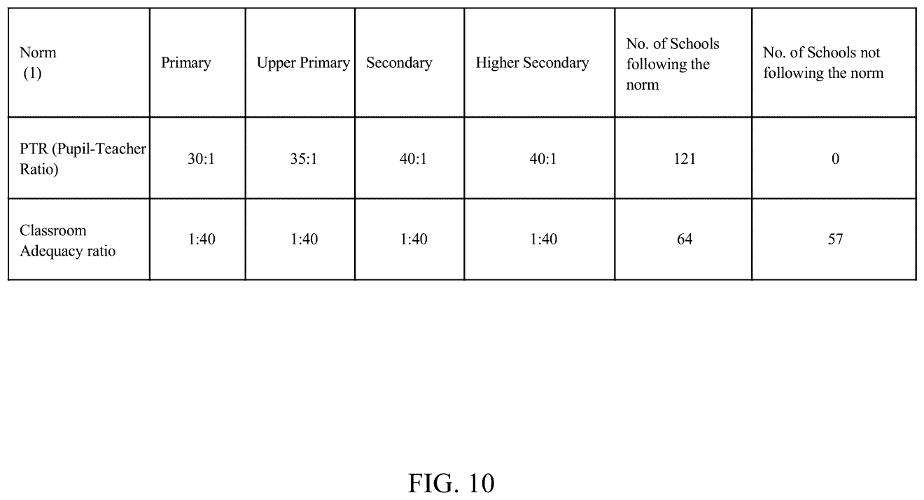

FIG. 10 depicts the standard requirement for pupil-teacher ratio and classroom adequacy ratio in an embodiment of the present invention. Looking at the FIG. 10, the pupil-teacher ratio for primary school is 30 to 1 whereas for higher secondary is 40 to 1. Likewise, the classroom adequacy ratio for primary school as well as for higher secondary school is 1 to 40.

The analytical platform 110 then performs the next step of assessing the education impact analysis and linking the school category to the pass percentage. The schools are divided into 5 categories—Category 5 (Upper Primary, Secondary & Higher Secondary), Category 6 (Primary, Upper Primary, Secondary), Category 7 (Upper Primary, Secondary), Category 8 (Secondary) and Category 10 (Secondary, Higher Secondary). It was found that category 5 and category 7 schools which has primary to secondary education had better results and better pass percentages as compared to those schools which only had secondary or higher secondary levels.

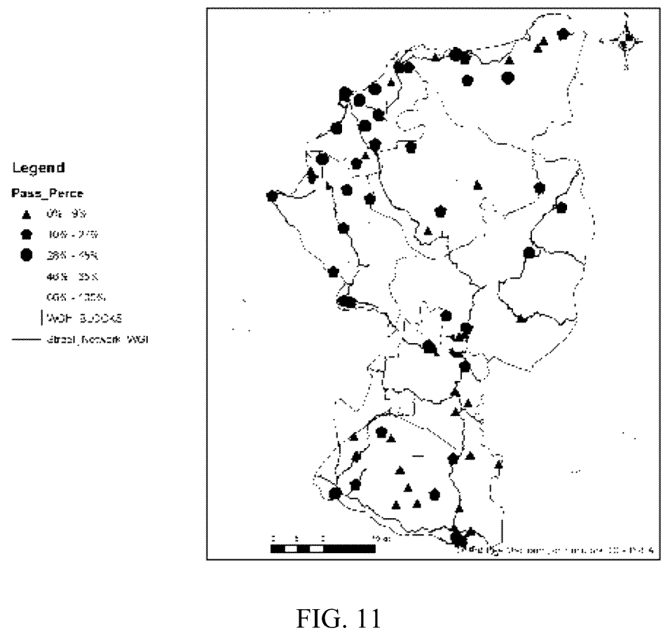

FIG. 11 illustrates the geospatial spread of pass percentage of the students in an embodiment of the present invention. As shown, the different schools have different pass percentage and the analytical platform 110 in at least one implementation performs a layered solution to improve the performance of the pass percentage.

The analytical platform 110 may perform the gap analysis with respect to the presence of primary, upper primary, secondary and higher secondary schools in each block by analysing the heat map of FIG. 11. In exemplary embodiment, the block may be a well defined area, for example, a 100 Sq. km area having one or more schools of different categories in it. The gaps in different levels of schools in each block may be with respect to different factors such as pass percentage, accessibility to schools, transportation or some other factors. One of the outcomes of the analysis is that the schools, which have primary level of education, or which have upper primary level to secondary level of education show better performance. The failure percentages of students are relatively less. In some embodiments, the geospatial spreads were analyzed in a separate layer independently of other layers for assessing the quality of school education.

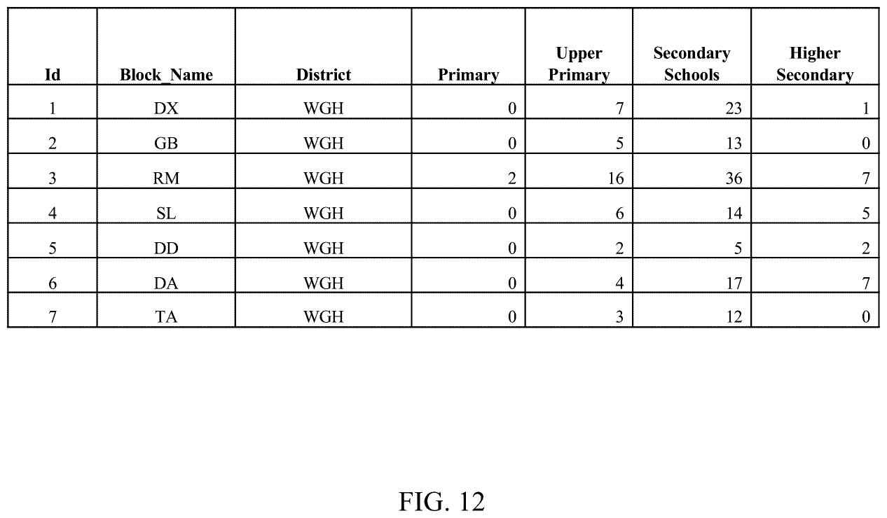

FIG. 12 show the distribution of different categories of schools in a block in an embodiment of the present invention. As shown, in an exemplary implementation, the block DX in WGH district has zero (0) primary school, seven (7) upper primary schools, twenty-three (23) secondary schools, and one (1) higher secondary schools.

Furthermore, the government standard for school accessibility were taken as standard for doing the analysis of school in a block. These standards are in form of distance, that is, the coverage with respect to the distance to be travelled by students to reach the school. The following standards are set based on the distance. In an exemplary embodiment, the standards may be defined as: Lower Primary—Walking distance of 1 KM; Upper Primary—Walking distance of 3 KM; Secondary—Walking distance of 5 KM; and Higher Secondary—Walking distance of 7 KM.

To check if the school is accessible from all parts of a particular block, buffers are drawn around each school as per the distance norms. The buffer analysis showed that the schools that are inaccessible from within the blocks indicate a gap in school coverage. Different assessment for accessibility of schools of secondary level were performed. For example, some of the secondary level schools may be inaccessible from some parts of different districts, which indicates that the secondary school coverage is not 100% as per the distance norms. In addition, the public transportation, like bus stops and taxi stands were mapped to check if the schools are accessible through public transportation. The schools having bus stops or taxi stands nearby were accessible whereas the school that did not had stops or taxi stands nearby showed gasp in accessibility. In some embodiments, the accessibility gaps were analyzed in a separate layer independently of other layers for assessing the quality of school education.

The analytical platform 110 further performs the step of determining the academic performance prediction. In preferred embodiment, this analysis is performed by the analytical engine 320. The artificial intelligence module 318 implements artificial intelligence algorithm/machine learning algorithms to predict pass percentage of the students across the schools. Total parameters/variables considered by the artificial intelligence module 318 for prediction of pass percentage of students leading to improvement of quality of education are 63, which include the demographic variable, schools and teacher information, infrastructure and facilities at the schools. In embodiments, the number of parameters used for prediction of pass percentages are 47 variables. Based on the historical data of these 47 variables, the machine learning model implemented in analytical engine 320, the analytical platform 110 can predict the pass percentage of the student in the coming year.

In embodiments, the pass percentages can be number of students transitioning from one standard to next higher standard.

This prediction of pass percentage of the students may be used for timely intervention, especially if the pass percentage levels fall below the threshold limit of 65%. The model used for pass percentage prediction of the students is the multivariate relevance vector machine (MVRVM) in at least one implementation.

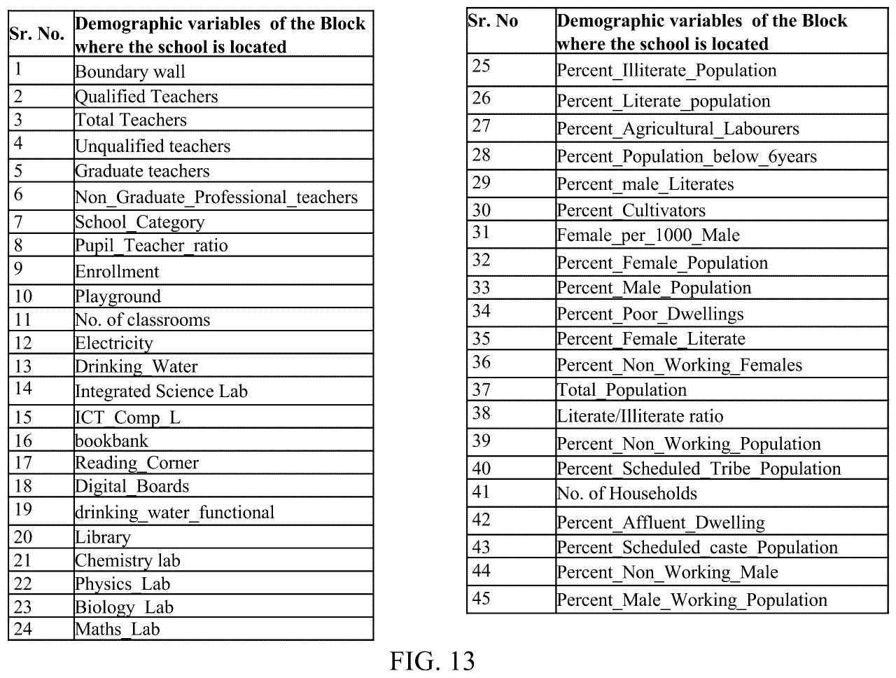

FIG. 13 illustrates the demographic variables of a school located in an exemplary block for prediction of pass percentage of students in an embodiment of the present invention. Each block has many variables such as boundary wall, qualified teachers, total teachers, unqualified teachers, graduate teachers and other variables as listed in FIG. 13. In embodiments, one or more variables may be used to predict the pass percentage of students leading to improvement in quality of school education.

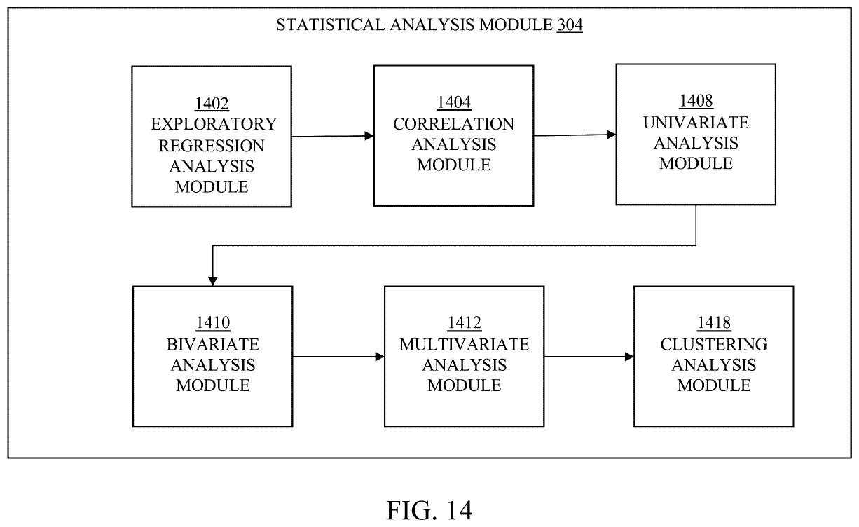

FIG. 14 illustrates a statistical analysis module in an embodiment of the present invention. The statistical analysis module 304 comprises of an exploratory regression analysis module 1402, a correlation analysis module 1404, a univariate analysis module 1408, a bivariate analysis module 1410, a multivariate analysis module 1412, and a cluster analysis module 1418. The exploratory regression analysis module 1402 is used to create and analyze the different features using regression analysis and to evaluate the relative importance of each of the features. The correlation analysis module 1404 analyzes different type of correlations such as positive and negative correlation, linear and non-linear correlation, simple, multiple, and partial correlation within the data. The features may be evaluated using univariate analysis or bivariate analysis and the statistical analysis module 304 uses the univariate analysis module 1408 or the bivariate analysis module 1410 for performing such an analysis. The cluster analysis module 1412 analyzes the data clusters during the statistical analysis to explore the relationship between different features.

The statistical analysis module 304 implements the clustering and dimension reduction techniques to create graphical displays of high-dimensional data containing one or more features. In some embodiments, the geospatial data and statistically data may be combined to produce a spatial representation and visualisation. The results are then combined with the results received from the machine learning algorithm to produce additional insights for improving quality of school education. In exemplary embodiments, the improvement in quality of school education may be related to improving the pass percentage of students form one standard to next higher standard.

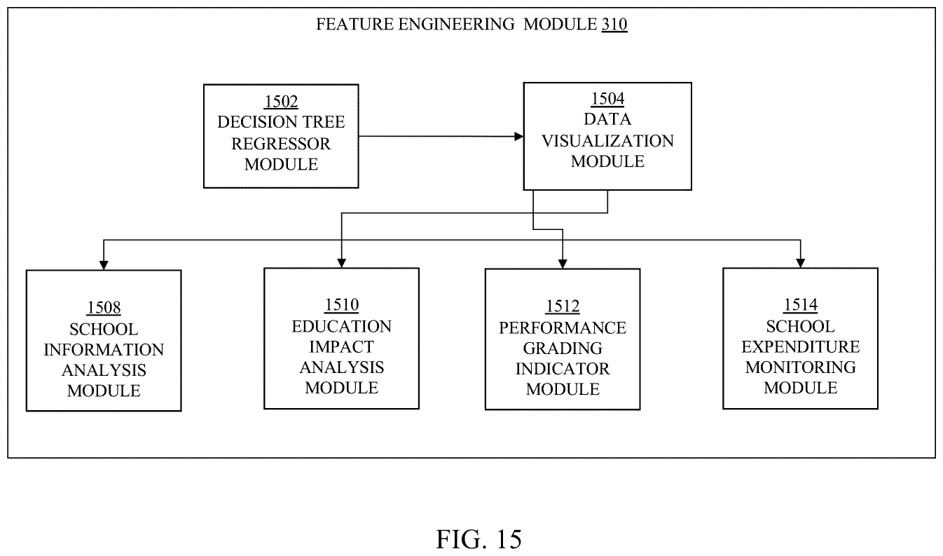

FIG. 15 illustrates different components of a feature engineering module in an embodiment of the present invention. The feature engineering module 310 includes a decision tree regressor module 1502, a data visualization module 1504, a school information analysis module 1508, an education impact analysis module 1510, a performance grading indicator module 1512, and a school expenditure monitoring module 1514. The feature engineering module 310 identifies the features that are relevant in the analysis of determining the quality of school education. The decision tree regressor module 502 creates a decision tree for the task of regression, which can be used to predict continuous valued outputs instead of discrete outputs. The output of the decision tree regressor 1502 is provided to the data visualization module 1504, which provides graphical data to analyze and understand the outcomes related to quality of school education. In some embodiments, the data visualisation module 1504 may be a dashboard, a graphical user interface or a customizable and interactive GUI. The data visualization module 1504 is connected with the school information analysis module 1508 that feeds school related information for graphical presentation. The education impact analysis module 1510 provides the impact of one or more features and further identifies the impact of the feature on the quality of education of the school. The performance grade indication module 1512 performs analysis of the previous grades using machine learning algorithms to forecast the grades of the students. The data visualization module 1504 may also receive data from the school expenditure monitoring module 1514 in some embodiments, and the performance and quality of school education may be also assessed based on the expenditure incurred by the school. In some embodiments, the prediction of performance of school and the quality of school education may be based on the expenditure incurred by the school. This may further be assessed as a separate layer.

The feature engineering module 310 identifies important features and analyzes them to create analytical models for assessing the quality of school education and further to forecast the pass percentage of the students. The data visualisation module 1504 may include a graphical user interface that allows a user/an operator to rearrange the features and apply different analytical models to analyze data. Further, the graphical user interface may allow the user or the operator to build different scenarios using different features/variables and constants to come up with an optimized and efficient analytical model.

In embodiments, the Multi-Variate Relevance Vector Machine (MVRVM) is used for building a model for prediction and improvement of quality of school education. The “Sparse Bayesian Learning” is used to describe the application of Bayesian automatic relevance determination (ARD) concepts to models that are linear in their parameters. A special case of this concept is the Relevance Vector Machine (RVM) which is applied to linear kernel models. In an embodiment, open-source code was used as a base to build the MVRVM model which was particular to this application. The data set is in the form of input-output pairs, {x tₙ, r}ₙ^{N P}==′1,r 1, where x is the input matrix, t is the target vector, P is the number of output dimensions and N is the number of observations. The major goal is to learn a model of dependency of the outputs on the inputs with the objective of making accurate predictions for previously unseen values of x.

In some embodiments, the data visualization module 1504 may combine data from multiple sources such as from school information analysis module 1508, the education impact analysis module 1510, the performance grading indicator module 1512 and the school expenditure monitoring module 1512 to arrive at data visualisation to uncover addition insights for the quality of school education (layer 1). This is further combined with geospatial data to arrive at another layer of insights (layer 2). In addition, this may be further combined with another layer (layer 3) that take into account the expenditure incurred by the school. This is referred as layered approach that provided better insights about the reason for poor performance of schools or alternatively good performance of some of the schools. In addition, it provides information related to key indicators that result in good performance of some school and bad performance of other schools.

In one implementation of the present invention, a layered approach is performed by the analytical platform 110 for determining the quality of school education. For example, the first layer may be associated with analysis of geospatial data. A second layer may be associated with determination of accessibility to the school. A third layer may be associated with identification and selection of dimensions using one or more statistical techniques. A fourth layers may be associated with analysis and determination of quality of school education using machine learning algorithms. In different implementations, the different layers can be combined in different ways to provide the set objectives, that is, improving the quality of school, improving the pass percentage of the school education or some other objectives.

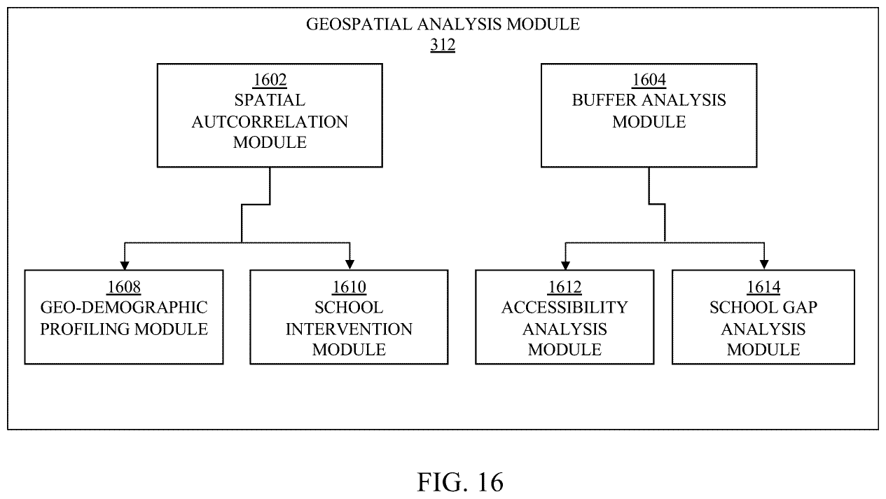

FIG. 16 illustrates a geospatial analysis module in an embodiment of the present invention. The geospatial analysis module 312 comprises a spatial autocorrelation module 1602, a buffer analysis module 1604, a geo-demographic profiling module 1608, a school intervention module 1610, an accessibility analysis module 1612 and a school gap analysis module 1614 apart from other modules that may be present in other embodiments. The spatial autocorrelation module 1602 exchanges the data with the geo-demographic profiling module 1608 and the school clustering module 1610. The spatial autocorrelation module 1602 identifies the pattern within the spatial data and uncovers any pattern in the geospatial data. This may be applied specifically to geo-demographic profiles of students, teachers, transportation, school management and other stakeholder associated with the school. The buffer analysis module 1604 is connected with the accessibility analysis module 1612 and the school gap analysis module 1614. The school clustering module 1610 evaluates how the cluster of different school may be organized.

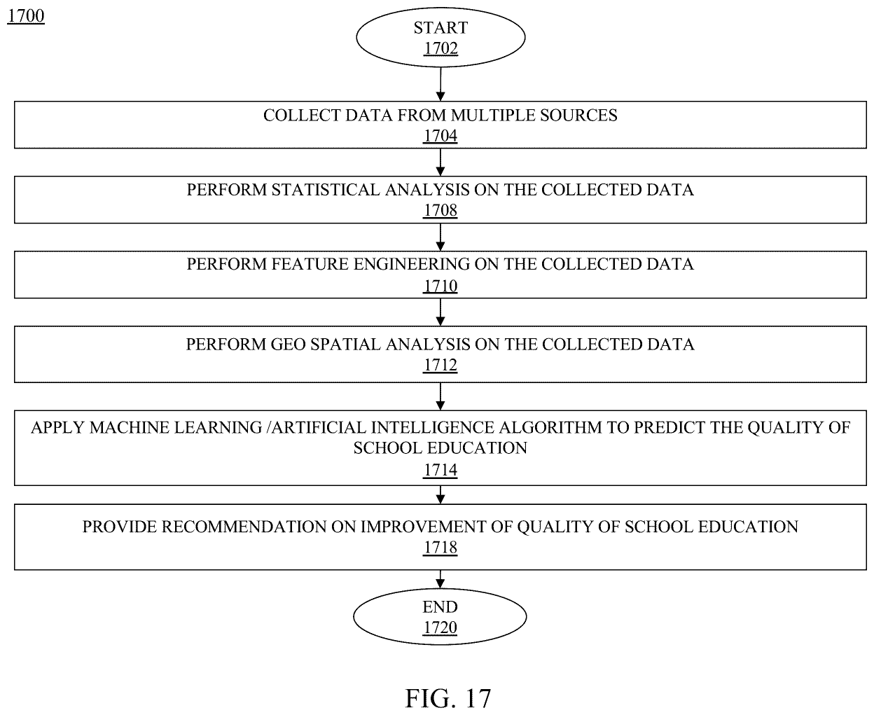

FIG. 17 illustrates a process of predicting the quality of school education in an embodiment of the present invention. The process 1700 starts at step 1702 and immediately moves to step 1704. At step 1704, the process 1700 collects data from multiple sources. In preferred embodiment, the process 1700 receives proprietary data from the proprietary data module 402 and the demographic data from the demographic data module 410 and other data from other modules. In addition, the process 1700 may also receive educational institutional data, research data, stakeholder data, school data, government data and ancillary data from different modules. In some embodiments, the process 1700 may check whether there is missing data, if so, the process 1700 may request for missing data from the data aggregation module 302. Simultaneously, the process 1700 may send an alert to the analytical platform 110 to collect the missing data. The data aggregated at step 1704 is analyzed and processed using one or more type of statistical techniques. At step 1708, the software implemented statistical techniques are utilized for data transformation, filtering and choosing the relevant dimensions. For example, the correlation analysis, determining the variance inflation factor and for dropping highly correlated variables. The statistical analysis may further include one or more algorithms for dimensionality reduction. The statistical analysis step 1708 identifies the correlation among dimensions and identification of relevant dimensions.

At step 1710, the process 1700 performs feature engineering using one or more statistical techniques. The feature engineering includes analyzing the features using decision tree regressor and performing variable weightage calculation to extract dimensions/variables, which can be utilized for prediction of quality of school education. At step 1712, the process 1700 performs geospatial analysis based on different parameters such as geo-demographic profiling of the school, school intervention analysis, school gap analysis and school accessibility analysis and other parameters related to school. For example, the geo-demographic profiling may use spatial autocorrelation. Likewise, the cluster analysis may use K-means algorithm for analyzing the school intervention analysis. A buffer analysis may be performed to analyze school gap analysis and school accessibility analysis. Once the relevant data for prediction is collected and prepared for analysis then at step 1714, the process 1700 applies machine learning and/or artificial intelligence algorithms to predict the quality of school education. The predicted results are analyzed and passed to the recommendation module. At step 1718, the process 1700 provides recommendation for predicting and improving the quality of school education. In some embodiments, the data collected at step 1704 may be processed in parallel to produce data analytics such as producing performance grading indicators and spatial representation and visualization to improve the quality of school education. The process 1700 terminates at step 1720. In some other embodiments, the data collected at step 1704 may be processed in parallel in different layers to improve the quality of school education.

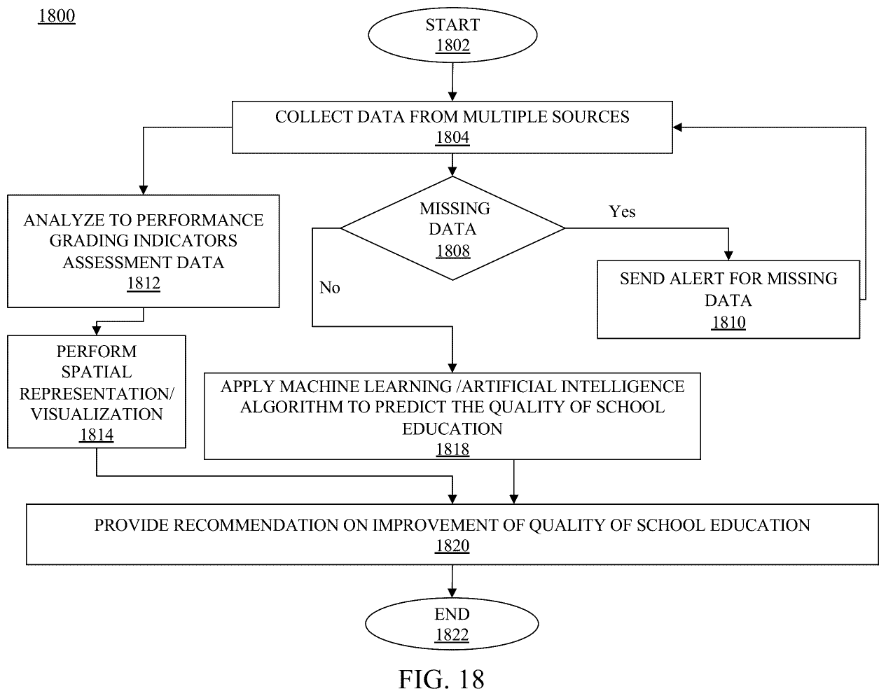

FIG. 18 illustrates a process of data aggregation and data visualisation in an embodiment of the present invention. The process 1800 starts at step 1802 and immediately moves to step 1084. At step 1804, the process 1800 collects data from different sources. At step 1808, the process 1800 determines if the there is any missing data. If there is missing data then at step 1810, the process 1800 sends an alert for missing data to the data aggregation module 302. If there is no missing data, the process 1800 moves to step 1818 to apply machine learning/artificial intelligence algorithms to predict the quality of school education as described in FIG. 17. The data collected at step 1804 may be passed to the step 1812 for analyses and identification of key performance grading indicators. For example, the data collected at step 1804 may combine propriety data with data from other modules and conclude that a key indicator is quality of teaching staff in the school. Additionally, at step 1814, the process 1800 may perform spatial representation on the aggregated data and infer that a key indicator of improvement in quality of school education is access to public transport. This result, when combined with the prediction with machine learning may provide new insights for improvement of quality of school education.

At step 1820, the process 1800 may combine the outcomes from the machine learning/artificial intelligence module for improvement of quality of school education and the data analytics of steps 1812 and 1814 to provide recommendation for improvement of quality of school education. The process 1800 may terminate at step 1822.

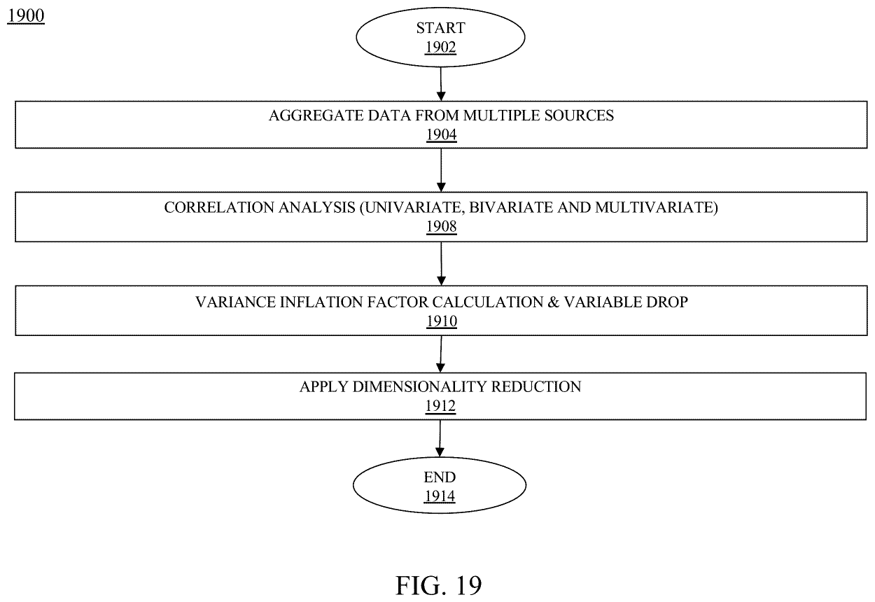

FIG. 19 illustrates a process of data filtering and transformation using statistical analysis in an embodiment of the present invention. The process 1900 starts at step 1902 and immediately moves to step 1904. At step 1904, the process 1900 collects data from multiple sources. At step 1908, the process 1900 applies correlation analysis to the data aggregated at step 1904. In embodiments, the process 1900 may apply univariate analysis or multivariate analysis to the aggregated data. For example, the process 1900 at step 1908 may determine which of the parameters are relevant for predication of quality of school education. In another example, the process 1900 may determine the correlation between different variables. For example, to check if there exists a self-correlation or an autocorrelation among different dimensions/variables. At step 1910, the process 1900 may determine the variance inflation factor and variance drop. The variance inflation factor is the ratio of the overall model variance to the variance of a model that includes only that single independent variable. It quantifies the severity of multicollinearity in an ordinary least squares regression analysis. Furthermore, the process 1900 may provide information in a GUI regarding the variables/dimensions, which can be dropped. At step 912, the process 1900 may apply the dimensionality reduction. The process 1900 may terminate at step 1914.

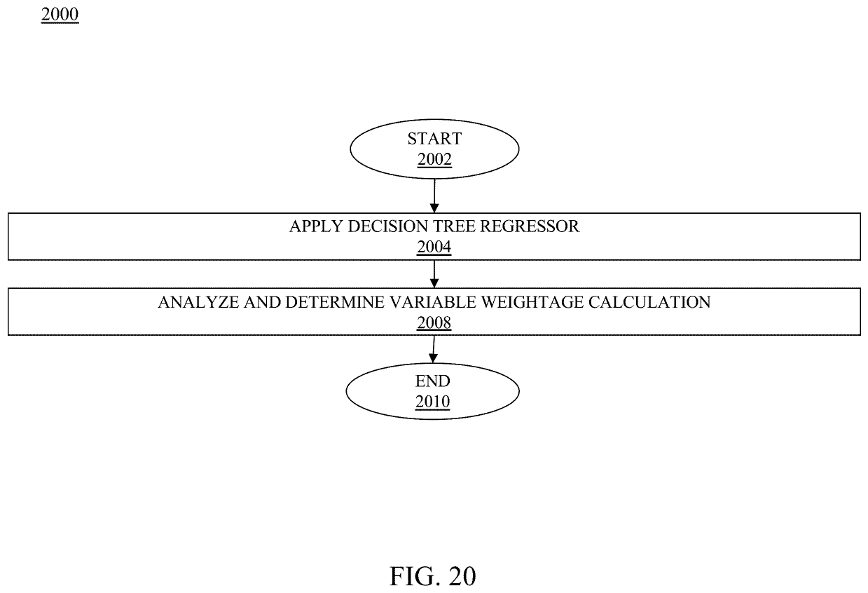

FIG. 20 illustrates the process of data transformation of relevant variables in an embodiment of the present invention. The process 2000 starts at step 2002 and immediately moves to step 2004. At step 2004, the process 2000 applies the decision tree regressor to the collected data. In some embodiments, the collected data may be processed using statistical techniques and subsequently applied with decision tree regressor. At step 2008, the process 2000 may analyze and determine variable weights to be applied in a univariate or a multivariate analysis. The process 2000 may end at step 1920.

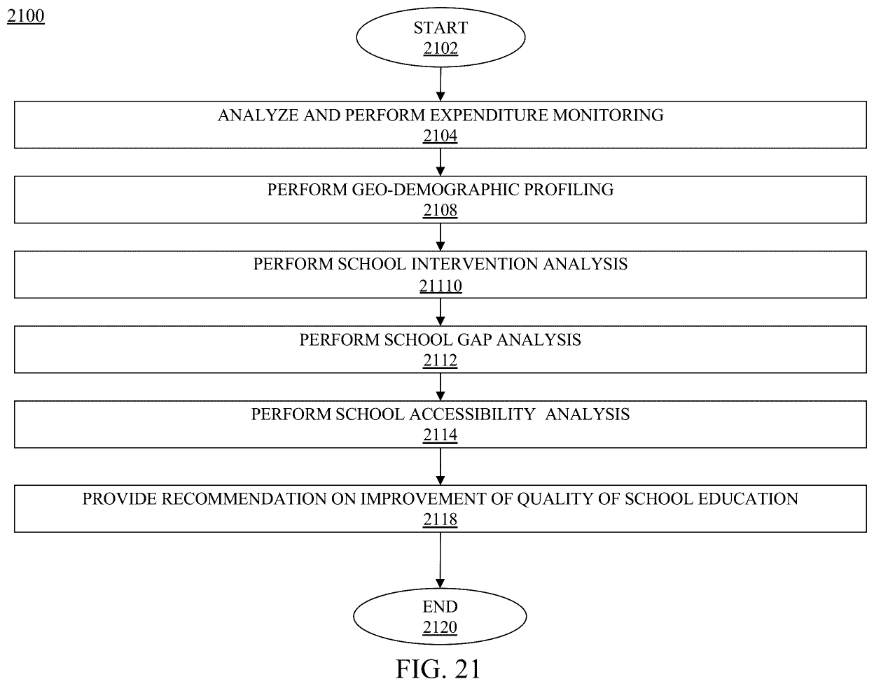

FIG. 21 illustrates a process of expenditure monitoring for improving the quality of school education in an embodiment of the present invention. The process 2100 is initiated at step 2102 and immediately moves to step 2104. At step 2104, the process 2100 analyzes the expenditure incurred by the school for improvement in school education. At step 2108, the process 2100 perform geo-demographic profiling of different parameters. In embodiments, the geo-demographic profiling may include terrain (geographical location), access to public transport, level of school etc. At step 2110, the process 2100 performs a school intervention analysis for improving the quality of school education. At step 2112, the process 2100 performs the school gap analysis to determine the factors responsible for low performance. At step 2114, the process 2100 performs the school accessibility analysis to determine the distance standards set by the govt. for accessibility of each category of school. The analytical platform 110 may implement a process to check if the school is accessible from all directions in a particular block by drawing buffers around each school as per distance norms. The buffer analysis will show whether the schools are accessible/inaccessible from within the block where they are present, which indicates the gap in school coverage. At step 2210, the process 2100 may provide recommendation on improvement of quality of school education. The process 2100 terminates at step 2100.

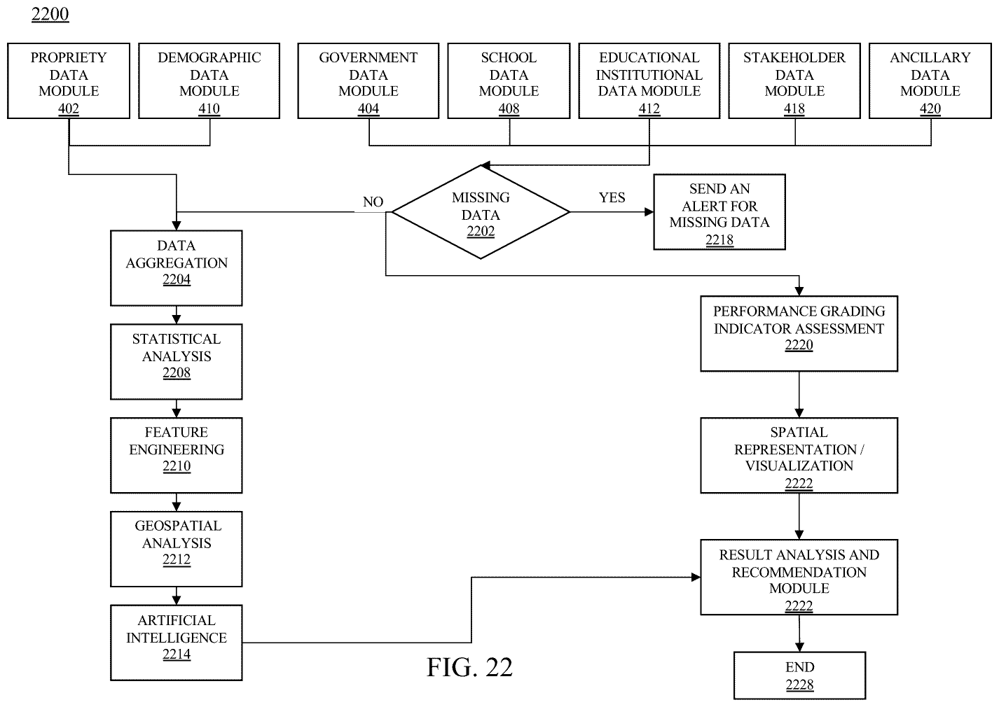

FIG. 22 illustrates a two layered process for improving the quality of school education in an embodiment of the present invention. The process 2200 collected data from different modules and then checks for missing data. At the first layer the process 2200 analysis the data by performing statistical analysis 2208, feature engineering 2210, geospatial analysis 2212, and then using machine learning algorithms provided in an artificial intelligence module 2214. In parallel, a second layer analyzes the aggregated data by performance grading indicator assessment 2220, spatial analysis/visualization 2222. The results of layer one and layer two are combined and processed using at least one of the statistical techniques and/or machine learning algorithms to arrive at in depth insight on factor for improvement of quality of school education.

In another embodiment, a three-layered approach may be implemented by using the first layer and the second layer as described. In addition, a third layer for accessibility analysis may be appended to arrive at recommendations. In yet other embodiments, another additional layer of key performance indicators may be added to arrive at recommendations.

The invention can be modified into many variations in different implementations and is not limited to different embodiments described herein. Other variations that can be amended or modified are within the scope of this invention.

We claim:

1. A computer implemented analytical platform for improving the education quality, the said computer implemented analytical platform comprising:
a data aggregation module configured to collect and aggregate data from a set of data sources;
a statistical analysis module for removing the interrelation among a set of variables;
a dimensionality reduction module to select a subset of variables from the set of variables;
a feature engineering module to calculate the importance of a feature by calculating feature weightages;
a geospatial analytics module for determining a gap in coverage and a visualization of accessibility of schools;
an analytical engine implementing machine learning algorithms, which are trained using a training and test dataset, the test dataset comprising a variable selected by the feature engineering module to optimize the set goals and tested on the test dataset;
an artificial intelligence module for prediction of a set of goals, and
a recommendation module for prediction of an outcome based on the set of goals.

2. The computer implemented analytical platform of claim 1, wherein each variable in the selected subset of variables is independent and statistically uncorrelated.

3. The computer implemented analytical platform of claim 1, wherein the dimensionality reduction module selects the subset of variables that impact the quality of school education.

4. The computer implemented analytical platform of claim 1, wherein the geospatial analytics module implements spatially mapping a set of data associated with a district comprising a set of blocks and each block in the set of blocks comprising a set of schools and mapping a set of demographics with success rate of the students using spatial autocorrelation.

5. The computer implemented analytical platform of claim 1, wherein the dimensionality reduction module drops a variable based on statistical analysis.

6. The computer implemented analytical platform of claim 1, wherein the feature engineering module selects the most critical set of variables affecting a pass percentage and assigning a weight to each variable in the set of variables in order of importance.

7. The computer implemented analytical platform of claim 1, wherein an artificial intelligence module is trained using a training data set and thereafter predict a pass percentage of a student a year in advance.

8. The computer implemented analytical platform of claim 1, wherein the data aggregation module evaluates the effectiveness of using ancillary data along with school information to improve the interpretability of a pass percentage prediction and the automatic regression of the aggregated data.

9. The computer implemented analytical platform of claim 1, wherein the accuracy of prediction of past percentage depends on a kernel width, a type of kernel, and a number of iterations.

10. The computer implemented analytical platform of claim 3, wherein the quality of school education is determined by a pass percentage of students in a set of school classes.
